(19) United States
(12) Patent Application Publication
(10) Pub. No.: US 2018/0340677 A1
(43) Pub. Date: Nov. 29, 2018

(54) Lantern

(71) Applicant: Alpine Corporation, Los Angeles, CA (US)

(72) Inventor: Sohrab Robby Soofer, Beverly Hills, CA (US)

(21) Appl. No.: 15/602,755

(22) Filed: May 23, 2017

(51) Int. Cl. F21V 17/00; F21L 4/08; F21V 3/04; F21V 15/01

(52) U.S. Cl. CPC F21V 17/002; F21L 4/08; F21W 2121/00; F21V 15/01; F21V 3/0436

(57) ABSTRACT

Provided is a lantern comprising: a) a housing; b) a window in the housing; c) a source of light; d) a power source for powering the light; e) a decorative transparent or translucent member placed inside of the housing, a portion of the decorative member visible through the window from outside of the housing; wherein the light travels from inside of the housing to outside of the housing through the decorative member.

### BACKGROUND SECTION OF THE INVENTION

Lanterns are a popular garden products. In addition to serving the purpose of lighting a garden, lanterns can also be used to decorate a garden. A problem with lanterns is that at some point consumers get tired of having the same lantern. There is a need in the art for a lantern that lights a garden, is decorative, and at the same time can be customized by a consumer.

### SUMMARY SECTION OF THE INVENTION

Provided is a lantern comprising: a) a housing; b) a window in the housing; c) a source of light; d) a power source for powering the light; e) a decorative transparent or translucent member placed inside of the housing, a portion of the decorative member visible through the window from outside of the housing; wherein the light travels from inside of the housing to outside of the housing through the decorative member. The power source can be a rechargeable battery. A solar panel can be included for charging the rechargeable battery. The solar panel and the light source art part of a solar module with a solar panel on top of the module, a light extending below the module, and the battery inside of the module. The lantern can further comprise a lid, the lid further comprising in its center a solar panel module housing the solar panel, the source of light, and the source of power. The source of light can be LED (Light Emitting Diode) light. The member can be in form of a sheet. The sheet can be rectangular. The sheet can be less than one inch in thickness. The member can be made from Poly(methyl methacrylate). The member can be a design element that is visible through the window. The member can be removably placed inside of the lantern. The lantern can be configured so that a user has option of choosing the member from plurality of members with different design elements. The slot can be for placing the member. The member can be removably placed in the slot. The lantern can further comprise an ornament attached to the housing in proximity to the window. The window can have a circular portion and a part of the ornament is placed around the circular portion. The ornament can be placed around the window and projects outward in front of the window. The housing can be cuboid.

Provided is a lantern comprising: a) a housing; b) a window in the housing; c) a solar panel module placed on top of the housing, the module having a solar panel at top, a source of light at bottom, and a rechargeable battery inside; d) a slot inside of the housing; e) a decorative transparent or translucent sheet placed removably in the slot, a portion of the decorative member visible through the window from outside of the housing; wherein light from the source of light that is powered by the rechargeable battery travels from inside of the housing to outside of the housing through the decorative member. This transparent or translated sheet can be colored, printed with various patterns, and/or textured.

### BRIEF DESCRIPTION OF THE DRAWINGS

FIG. 1 illustrates a lantern with a bird design.

FIG. 2 illustrates a cross-section view of the lantern.

FIG. 3 illustrates a sheet having a design element.

FIG. 4 illustrates a lantern with a butterfly design.

FIG. 5 illustrates a lantern with a sunflower design.

FIG. 6 illustrates a lantern with a ladybug design.

FIG. 7 is a simplified diagram illustrating possible electrical circuits for the lantern.

### DETAILED DESCRIPTION OF THE INVENTION

Provided is a lantern with a window that is configured to allow a consumer to change the looks of the lantern by changing the design that can be seen through the window. In one embodiment, a consumer can change plexiglass or decorative sheets with different designs as desired, for example changing the design based on the season or the taste of the consumer. The decorative sheet can be plexiglass, vinyl, PVC (polyvinyl chloride), glass, metal, fabric, or wood.

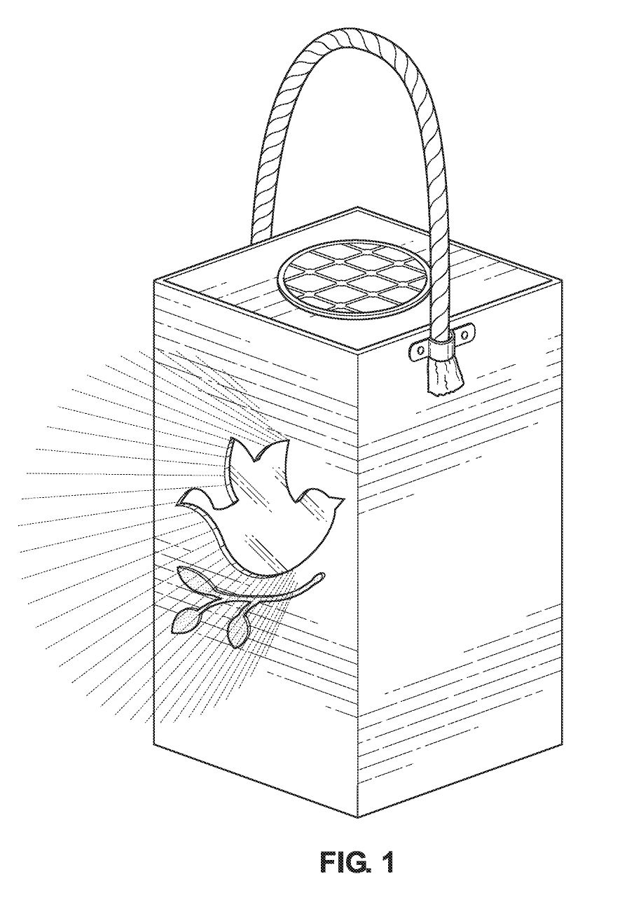

FIG. 1 illustrates a lantern with a bird design. The lantern 1 can have a housing 2. In this embodiment, the housing is shaped like a cuboid, with longer height than width. The top of housing 2 can have a lid 3. The lid 3 can have an opening for placement of a solar panel 4. Solar panel 4 is placed on top of lantern 1 in such way that ambient light can hit the solar panel. Lantern 1 has window 8 on one side (or multiple sides), which can be made by cutting through the side of the housing 2 in the elevational position. In this figure, the window 8 is shaped like an animal more specifically a bird. Below the bird is placed an ornament 9, which can be attached to housing 2 with an adhesive or a fastener. Ornament 9 can be made from wood, metal, or resin material like plastic. The lantern 1 can have a handle 5. Handle 5 can be a rope, shaped like a rope, or have other designs. The handle 5 can be made from natural or synthetic materials. The handle 5 can be attached to opposite sides of housing 2 with brackets 6. Brackets 6 can be attached to sides of housing 2 where window 8 is not placed. Housing 2 can be made from a material that is opaque or translucent, like wood, metal, glass, or PVC. In one embodiment, housing 2 is made from an opaque material.

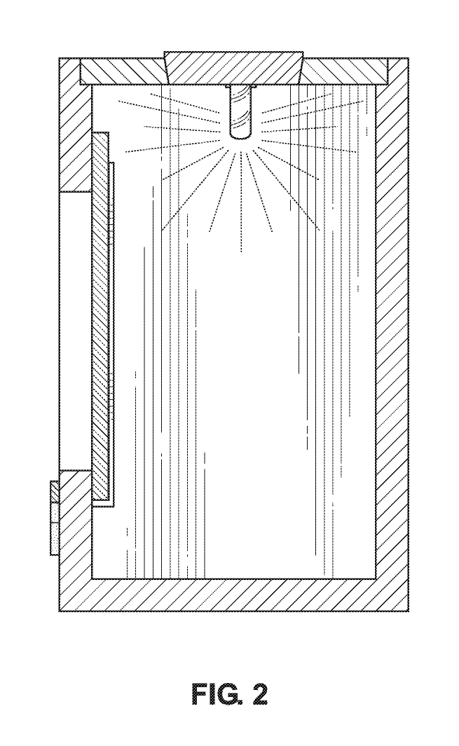

FIG. 2 illustrates a cross-section view of lantern 1. Visible in this figure is inside of the lantern 1. A source of light 10 is attached to solar panel module 15 and lights up inside of the lantern 1. The source of light 10 can be an LED light. Sheet 9 is placed behind window 8 inside of lantern 1. A slot 12 exists behind window 8 inside of lantern 1. The slot 12 is created by placing holder 11 in parallel configuration to window 8. The top of slot 12 is accessible from the top. A user can remove lid 3 of housing 2, and place/change the sheet 14 as desired. Side of ornament 9 is also visible in this view.

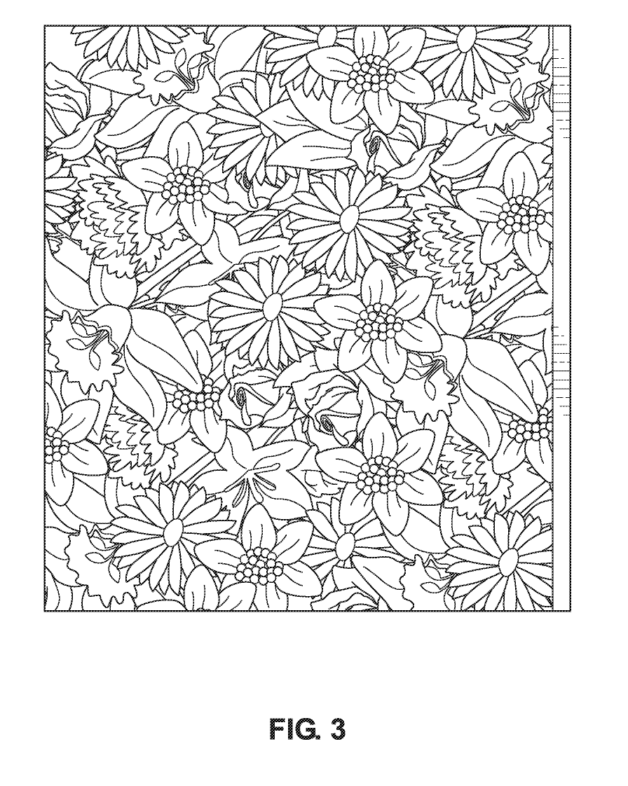

FIG. 3 illustrates a sheet having a design element 7 of flowers. Sheet 14 can be made from a transparent or translucent material that allows for passage of some light from inside of lantern 1 to outside of lantern 1. The sheet 14 can be made from synthetic material like plastic, resinous material or silica based glass. In one embodiment, the sheet 14 is made of Poly(methyl methacrylate) (PMMA), which is also known as acrylic or acrylic glass as well as by the trade names Plexiglas®, Acrylite®, Lucite®, and Perspex® among several others. PMMA is a transparent thermoplastic often used in sheet form as a lightweight or shatter-resistant alternative to glass. Inks and coatings can be used to be put a design element on the Plexiglass. Examples of ink that can be used include Jacquard® Professional Screen Printing Ink. A printed paper can be placed on the Plexiglass or the Plexiglass itself can be printed/etched upon. The sheet 14 can have any geometric shape that is suitable for placement in slot 12. As shown in the figures, the sheet 14 has a rectangular shape. The sheet 14 typically has a thickness of 0.1 to 2 cm.

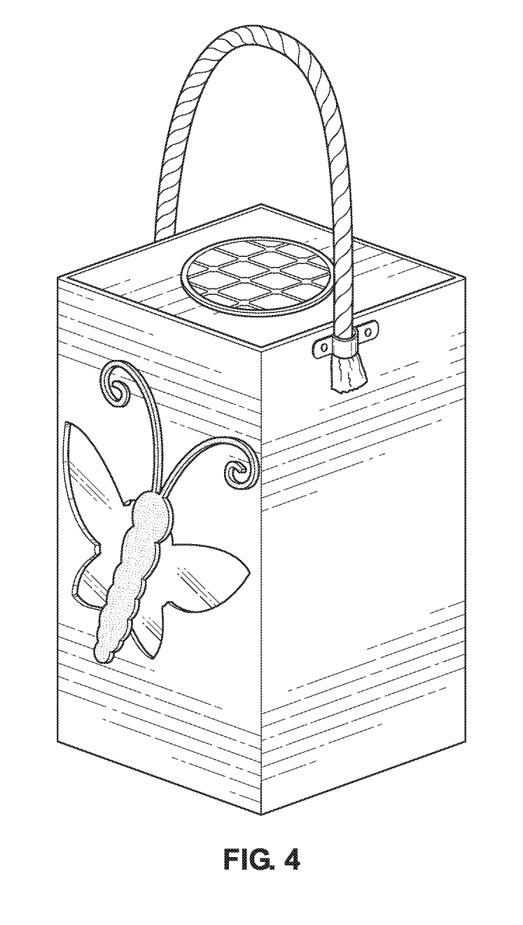

FIG. 4 illustrates a lantern 1 with a butterfly design. The window 8 is shaped like the wings of a butterfly. Ornament 10 representing the body and the antennas of the butterfly is placed directly on window 8. The design of window 8 can be changed, for example, to have butterflies with different colors and wings.

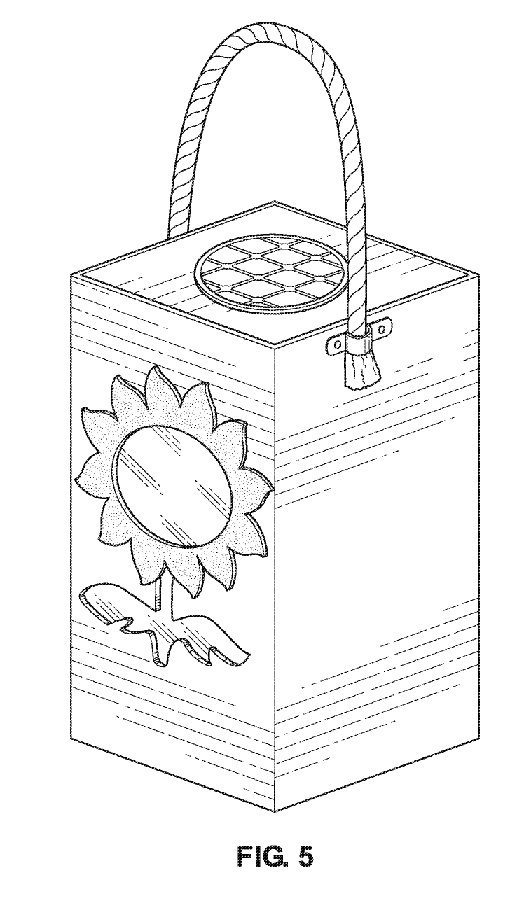

FIG. 5 illustrates a lantern 1 with a sunflower design. Window 8 is cut with a sunflower design. An ornament 10 representing the petals of the sunflower is placed all around the circular portion of the window 8 representing the seed portion of the sunflower. The petal ornament 10 can also overlap with a portion of the window 8 representing the stem of the sunflower.

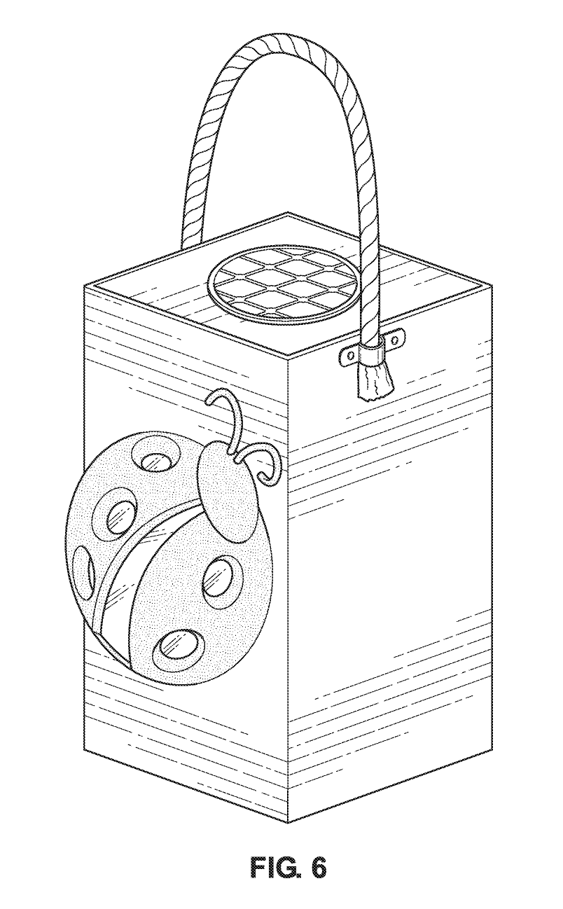

FIG. 6 illustrates lantern 1 with a ladybug design. Ornament 10 is in shape of a ladybug and is placed over a circular window 8 on lantern 1. Ornament 8 is shaped like a partial sphere (semi-sphere or smaller) and complements the circular shape of window 8. Ornament 10 can have a plurality of circular and other shaped openings. Ornament 10 can also have a portion outside of the sphere representing the head and antennas of the ladybug.

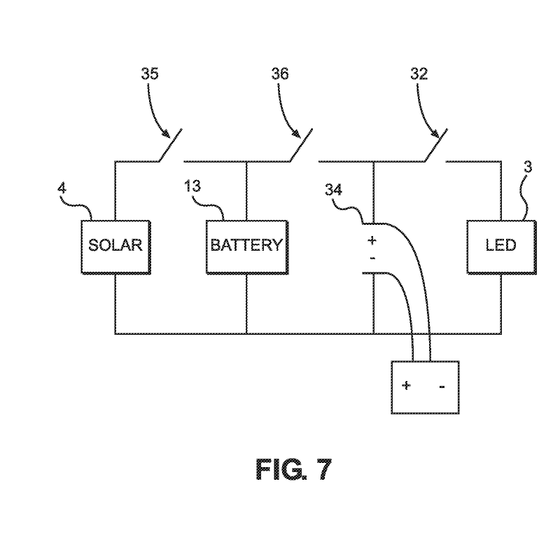

FIG. 7 illustrates an exemplary electronic connection between the solar panel 4, rechargeable battery 13, and light source 4. An internal switch 35 can be present in between the solar panel and the battery 13. The electronics can further include a light sensor, which can switch on or off the charging of the rechargeable battery 13 when the ambient light level is below a certain threshold. When light falls below a predetermined level the internal switch 35 may cut power from the solar panel to the battery 13. In another embodiment, the internal switch does not exist. An external/internal switch 36 can be used to cut power from the battery 13 to the light 3, and/or entirely shut the light source 3 other than for allowing the battery 13 to be charged by the solar panel 4. In another embodiment, an outside source of electricity 34, such as an outlet, is used to charge battery 13. Additional internal/external switch 32 can be present in between the light 3 and outside source of power 34. The switches can be part of a power management unit. The entire circuitry of FIG. 7 can be inside the solar panel module 15.

### REFERENCES

1. Lantern
2. Housing
3. Lid
4. Solar Panel
5. Handle
6. Bracket
7. Design element
8. Window
9. Ornament
10. Light Source (LED)
11. Holder
12. slot
13. Rechargeable battery
14. Sheet
15. Solar panel module
32. Switch
34. Outside Source of power (outlet)
35. Switch
36. Switch

What is claimed is:

1. A lantern comprising:
a) a housing;
b) a window in the housing;
c) a source of light;
d) a power source for powering the light;
e) a decorative transparent or translucent member placed inside of the housing, a portion of the decorative member visible through the window from outside of the housing;
wherein the light inside of the housing travels from inside of the housing to outside of the housing through the decorative member.

2. The lantern of claim 1, wherein the power source is a rechargeable battery.

3. The lantern of claim 2, further comprising a solar panel for charging the rechargeable battery.

4. The lantern of claim 3, wherein the solar panel and the light source art part of a solar module with a solar panel on top of the module, a light extending below the module, and the battery inside of the module.

5. The lantern of claim 1, further comprising a lid, the lid further comprising in its center a solar panel module housing the solar panel, the source of light, and the source of power.

6. The lantern of claim 1, wherein the source of light is LED (Light Emitting Diode) light.

7. The lantern of claim 1, wherein the member is a sheet.

8. The lantern of claim 1, wherein the sheet is rectangular.

9. The lantern of claim 7, wherein the sheet is less than one inch in thickness.

10. The lantern of claim 1, wherein the member is made from Poly(methyl methacrylate).

11. The lantern of claim 1, wherein the member has a design element that is visible through the window.

12. The lantern of claim 1, wherein the member is removably placed inside of the lantern.

13. The lantern of claim 1, wherein the lantern is configured so that a user has option of choosing the member from plurality of members with different design elements.

14. The lantern of claim 1, further comprising a slot of placing the member.

15. The lantern of claim 14, wherein the member is removably placed in the slot.

16. The lantern of claim 1, further comprising an ornament attached to the housing in proximity to the window.

17. The lantern of claim 16, wherein the window has a circular portion and a part of the ornament is placed around the circular portion.

18. The lantern of claim 16, wherein the ornament is placed around the window and projects outward in front of the window.

19. The lantern of claim 1, wherein the housing is shaped as a cuboid.

20. A lantern comprising:
a) a housing;
b) a window in the housing;
c) a solar panel module placed on top of the housing, the module having a solar panel at top, a source of light at bottom, and a rechargeable battery inside;
d) a slot inside of the housing;
e) a decorative transparent or translucent sheet placed removably in the slot, a portion of the decorative member visible through the window from outside of the housing;
wherein light from the source of light that is powered by the rechargeable battery travels from inside of the housing to outside of the housing through the decorative member.
